(19) United States
(12) Patent Application Publication
(10) Pub. No.: US 2005/0084821 A1
(43) Pub. Date: Apr. 21, 2005

(54) Abutment system

(76) Inventors: Lawrence O. Sims, Alpharetta, GA (US); Brian K. Lindke, Buford, GA (US); Yuichi Ikenaga, Buford, GA (US)

Correspondence Address: BRYAN W. BOCKHOP, ESQ.;ARNALL GOLDEN GREGORY LLP, 171 17TH STREET, SUITE 2100, ATLANTA, GA, 30363, US

(21) Appl. No.: 10/960,180

(22) Filed: Oct. 7, 2004

Related U.S. Application Data
(63) Continuation-in-part of application No. 10/689,179, filed on Oct. 20, 2003.

(51) Int. Cl. A61C 8/00

(52) U.S. Cl. 433/173

(57) ABSTRACT

An abutment system for a dental implant includes an abutment and a shoulder. The abutment has a base portion that is engageable with the implant. The shoulder is disposed about the base portion and includes a hybrid ceramic material. The hybrid ceramic material is applied to the abutment system so that the abutment system conforms to the patient-specific criterion. The hybrid ceramic material is then cured. The shoulder may be affixed to the abutment at a post-manufacturing dental facility.

### CROSS REFERENCE TO A PREVIOUSLY-FILED U.S. PATENT APPLICATION

This patent application is a continuation-in-part claiming priority on U.S. patent application Ser. No. 10/689,179, filed on Oct. 20, 2003, the entirety of which is hereby incorporated by reference.

### BACKGROUND OF THE INVENTION

1. Field of the Invention

The present invention relates to abutments used in implant dentistry and, more specifically, to an abutment system having an abutment with a shoulder that includes a hybrid ceramic material. The present invention also relates to a comprehensive abutment try-in protocol for determining correct abutment selection, including specifically an abutment to be chosen and placed at the time of first stage implant surgery, also known as an immediate load abutment, and hybrid ceramic temporary shells for the purpose of fabricating immediate load temporaries at the first stage surgical appointment of implant placement.

2. Description of the Prior Art

When a permanent crown is installed in a patient's mouth, the procedure that is generally followed is that an implant is first surgically placed into the patient's jawbone, and the crown is affixed to the implant device by use of an abutment, which is a substantially cylindrical device that is typically screwed into the implant, and the crown is then affixed on top of the abutment. It is well known in the art that a shoulder can be affixed to or shaped on the base portion of the abutment. The purpose of the shoulder is to provide a more seamless transition between the abutment and the gum tissue. Ideally the shoulder rests just below the crest of the gum tissue.

There are many problems and difficulties associated with the current state of implant dentistry. First, when a permanent crown is going to be implanted, an impression of the patient's mouth, which will be used to create the abutment system-and the crown, is taken in the dentist's office, and then sent to a dental laboratory, and the dental laboratory manufactures the crown. Because gum tissue changes over time, by the time the dental laboratory manufactures the abutment system and the crown and sends them back to the dentist to be affixed in the patient's mouth, the dimensions of the patient's mouth, in particular the shape of the gum tissue, will likely have changed. Therefore, the abutment system and/or the crown may no longer fit as well into the patient's mouth. As a result, the crown may not appear natural in the patient's mouth. For example, there may be a gap, or margin, between the base of the crown and the patient's gum line, such that the base portion of the abutment is visible. This is highly undesirable, particularly because the abutment is usually manufactured from a metal substance. This is also problematic because, once the shoulder has been formed about the base of the abutment, it can be reduced in size, such as by grinding it down, but no material can be added to it in order to shape it to better fit in the patient's mouth. Rather, an entirely new abutment system has to be made.

Another problem associated with implant dentistry arises when a small tooth is being replaced with a permanent crown. When a small tooth is replaced, the permanent crown likewise must be very small. Because the abutment is of a predetermined width, the permanent crown will be very thin. As the crown is made of porcelain, it is very fragile. The thinner the crown, the more fragile it is. Thin crowns have a tendency to break. If a portion of the crown breaks off when the dentist is affixing it in the patient's mouth, the dentist must request that the dental laboratory manufacture another crown. This results in additional time during which the patient must wait for the permanent crown to be affixed.

Another problem associated with implant dentistry is that some patients are sensitive to the toxicity of the acrylic monomers that are present in the materials that are commonly used as components of the materials that are used to form the shoulder about the base portion of the abutment, as well as the crown. If a patient has a reaction to the acrylic monomers that are present in the crown or the shoulder, this will compromise the healing of the gum tissue after the crown is affixed, and may require removal of the crown and the abutment system.

Another problem with crowns is the difficulty they have in duplicating the appearance of a natural tooth. As they are currently made, the composition of porcelain and acrylic material that is used to make the crown is not highly polishable. As a result, it is difficult to make the permanent crown have the appearance of a natural tooth. Another problem associated with dental implants is lack of light transmission into the soft tissue surrounding the implant. This causes a graying of the tissue directly around the implant because metal, pure zirconia and aluminum oxide abutments cannot transmit light.

Another problem associated with dental implants is that the implant fixture is frequently placed in the bone at an angle that makes it extremely difficult to restore with currently available abutments. The fixture may be angled towards the buccal, the lingual or interproximals. The fixture is also frequently positioned too high or too low in relation to the bone and/or gum tissue.

Another problem associated with dental implants is the temporization of temporary or permanent implant abutments. Implant abutments are frequently placed at an angle that precludes the use of traditional temporary crowns. Temporization is further complicated if attempted at the time of first stage surgery, as in an immediate load situation. Another problem associated with dental implants is the inability to load the implant fixture at the time of first stage surgery. This requires the use of a permanent abutment and a temporary crown. Fabricating and placing temporaries at this surgery is not a common procedure and requires a great deal of time as well as the use of traditional temporary modalities which are very impractical for this procedure. This procedure is also very time-consuming and not very cost effective.

Another problem associated with dental implants is that the materials that are commonly used to form the shoulder about the base of the abutment may not be compatible with all metals. Therefore, the material that can be selected to form the shoulder may be limited by the compatibility of that material with the type of metal that was used to create the abutment.

Another problem associated with current abutment systems is that the material used to form the shoulder about the base of the abutment may not be biocompatible with the patient's gum tissue, thereby hindering the healing process once the crown has been affixed. If the gum tissue does not heal properly around the implant and abutment system, infection and gum tissue loss can result.

Another problem associated with dental implants is the inability to select the final abutment by the surgeon and restorative dentists. The dental laboratory typically decides what the configuration of the abutment will be by analyzing the plaster impressions taken of the patient's mouth. This prevents the surgeon or restorative dentist from being able to observe and possibly correct any angle problem or tissue height discrepancy.

### SUMMARY OF THE INVENTION

The disadvantages of the prior art are overcome by the present invention, which in one aspect, is an abutment system. In the abutment system, the abutment has a shoulder disposed about the base of the abutment. The abutment is typically an opaqued metal cylinder, a metal oxide (such as aluminum oxide, zirconium oxide or titanium oxide) cylinder, a tooth colored fiber reinforced cylinder, or a pure zirconia cylinder that is affixed to the implant fixture by a screw. The shoulder includes a hybrid ceramic material. The hybrid ceramic material includes at least 80% porcelain or other inorganic filler, and, in one embodiment, includes at least 92% porcelain. The characteristics of the hybrid ceramic material allow a shoulder to be modified after the shoulder has already been formed, including allowing for additional hybrid ceramic material to be added onto the already existing shoulder. This allows the oral surgeon or restorative dentist to modify the abutment at any time so as to allow for a desired shape, contour, and margin placement. This is accomplished either by adding to or by reducing the shoulder area of the abutment. This can be done in the dentist's office rather than having to send the abutment system back to the dental laboratory for adjustment. This also results in minimal margin existing between the gum tissue and the crown once the crown is installed.

Another advantage of the invention is that it has the ability to correct the divergent angle created by the implant fixture. Not only can the length of the abutment be modified, the shoulder can be reconfigured to accommodate an angulation problem. Shoulder height, width, and emergence profile can all be added to or reduced to exact size and shape.

The ability to add hybrid ceramic material to the shoulder even after it is formed overcomes the problems associated with crowns that break in the dentist's office. If a crown breaks, the dentist can add hybrid ceramic material to the abutment system in the place of the broken portion of the crown. This is an acceptable solution because the hybrid ceramic material is highly polishable and is transluminescent, and therefore has the appearance of a natural tooth, including below the gum line. Hybrid ceramic materials have the ability to transmit light from the margin/shoulder area to beneath the gum tissue. This light transmission has never been accomplished to such a high degree with previous abutment shoulder materials. This ability to transmit light eliminates the traditional graying of the tissue surrounding the implant.

Another advantage of the present invention is that the hybrid ceramic material is highly biocompatible. Gum tissue that is in contact with the hybrid ceramic material responds well and heals at a predictable rate. The success of the abutment system and crown is enhanced by the very low risk of a negative reaction to any monomers that might be present in the hybrid ceramic material. Because the hybrid ceramic material includes a very low percentage of acrylic monomer initially, the risk of a negative reaction is reduced. The risk is further reduced because the final curing step of the method of making the abutment system entails exposing the abutment system to heat, which drives off any additional remaining monomer in the hybrid ceramic material.

Another advantage of the present invention is that the hybrid ceramic material is compatible with all metals that are used for abutments, thereby eliminating this concern.

Another advantage of the present invention is that the shoulder can be formed about the abutment so that the shoulder extends out over a portion of the gum tissue, which, when pigment is added to the hybrid ceramic material that extends out over the gum tissue, creates the appearance of additional gum tissue. This is not only aesthetically desireable in some cases, as it creates a uniform appearance to the gum tissue, it can aid the regeneration of the actual gum tissue due to the reduced size of the biological width.

In another aspect, the invention is an abutment system for a dental implant that includes an abutment and a shoulder. The abutment has a base portion that is engageable with the implant. The shoulder is disposed about the base portion and includes a hybrid ceramic material. The hybrid ceramic material includes an organic matrix and at least 80% inorganic filler by weight.

In another aspect, the invention is a method of preparing an abutment system, including an abutment and a shoulder, in which a patient-specific criterion is measured. A hybrid ceramic material is applied to the abutment system so that the abutment system conforms to the patient-specific criterion. The hybrid ceramic material is then cured.

In yet another aspect, the invention is a method of making a dental abutment system in which an abutment is delivered to a post-manufacturing dental facility. A shoulder, that fits about at least a portion of the abutment, is delivered to the post-manufacturing dental facility. The shoulder is affixed to the abutment at the post-manufacturing dental facility.

These and other aspects of the invention will become apparent from the following description of the preferred embodiments taken in conjunction with the following drawings. As would be obvious to one skilled in the art, many variations and modifications of the invention may be affected without departing from the spirit and scope of the novel concepts of the disclosure.

### BRIEF DESCRIPTION OF THE FIGURES OF THE DRAWINGS

FIG. 1 is a diagram that demonstrates a method of making the abutment system disclosed herein.

FIG. 2 is a view of a kit of abutment systems.

FIG. 3 is a front view of a shoulder as described herein.

FIG. 4 is an exploded front view of an abutment system disclosed herein.

FIGS. 5A-C are front views of a placement of a dental implant, a shoulder and a crown in relation to the gum tissue.

FIG. 6 is a front view of the present invention where pigment has been added to a portion of the hybrid ceramic shoulder.

FIG. 7A-C are front views of various angled try-in abutments included in a kit.

FIG. 8A is a front view of two try-in abutments that have been affixed to dental implants.

FIG. 8B is an exploded front view of two hybrid ceramic shells affixed to the try-in abutments shown in FIG. 8A.

FIGS. 9A-B are front views of two hybrid ceramic shells that are part of a kit.

FIGS. 10A-F are front top perspective views of shoulders having a plurality of form factors.

FIGS. 11A-B are front top perspective views of implant systems that include build-up elements.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” As used herein, “hybrid ceramic” is defined to mean a material that includes a resin matrix and at least 80% inorganic filler by weight. It is also understood that the figures are not necessarily drawn to scale.

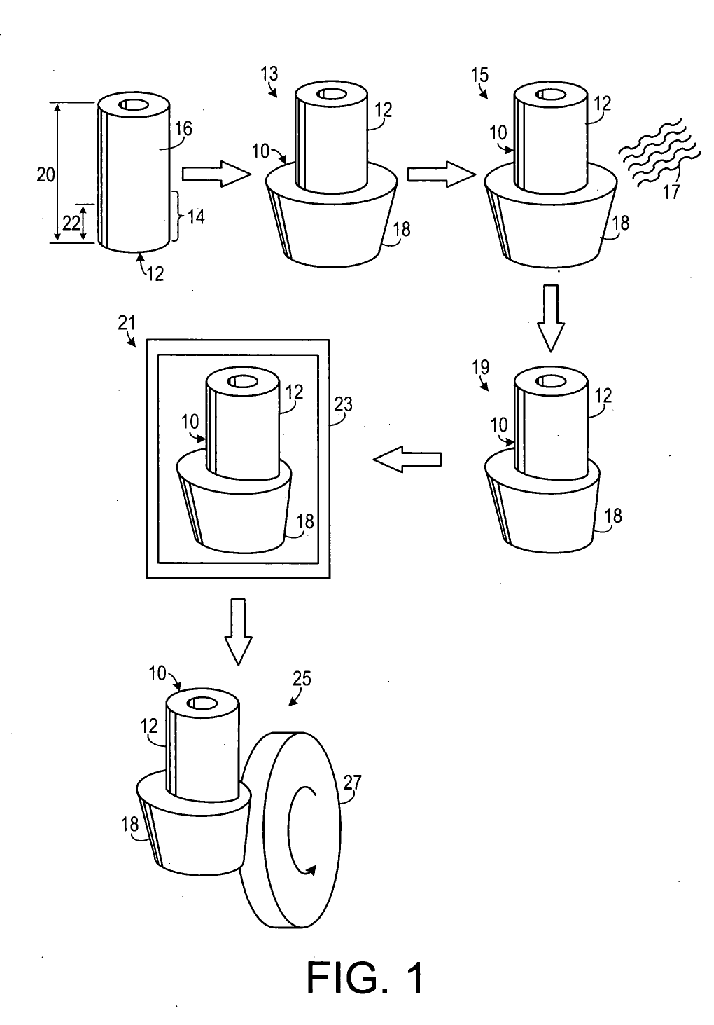

A method for making an abutment system is shown in FIG. 1. After an impression is taken of the patient's mouth and the appropriate criteria for making the abutment system 10 are determined, an abutment 12 is selected according to those patent specific criteria. The abutment 12 has a base portion 14. In one method for making the abutment system 10, an opaque is applied to at least a portion of the exterior surface 16 of the abutment 12. A shoulder 18 is formed 13 about the base portion 14 of the abutment 12 using a hybrid ceramic material. The abutment 12 and the shoulder 18 may be supplied separately to a post-manufacturing dental facility, such as a dental office or a dental laboratory, and assembled by a dental healthcare professional (such as a dentist, oral surgeon, periodontist, implantologist or dental laboratory technician).

Hybrid Ceramics are advanced composite materials that include an organic matrix (such as dimethylacrylate monomers) with inorganic fillers, such as porcelain. Such ceramics are typically reinforced by loading a large quantity of ultra-fine fillers (particle size 0.02 μm) into a microfilled (particle size 2 μm) resin matrix. One example of a suitable hybrid ceramic material is Estenia®, manufactured by Kuraray Medical, Inc., 1621 Sakazu, Kurashiki, Okayama, 710-8622 Japan, a manufacturer of dental products. This type of hybrid ceramic includes an organic resin (such as a dimethylacrylate monomer) matrix filled with ceramic fillers, approximately 92% by weight, or 82% by volume. The filler includes a silica quartz glass that includes a plurality of grains, with each grain being coated with an adhesive. Such hybrid ceramics offer an outstanding high density with a nearly homogeneous structure and excellent physical properties. The high ceramic filler content provides high compressive strength (about 613 MPa) and durability for posterior restorations. The flexural strength of 202 MPa is three times the strength than that of porcelain, a feature that is important for avoiding fractures. Its hardness of 190 HV is similar to gold alloy, minimizing the abrasion of the opposing tooth. With its high mechanical strength and superior wear and stain resistance this type of hybrid ceramic offers aesthetic restorations that are suitable for posterior occlusal surfaces.

In one embodiment of the invention, the hybrid ceramic material includes at least 80% ceramic filler. The ceramic filler in this embodiment comprises porcelain. In another embodiment, the hybrid ceramic material includes at least 92% ceramic filler.

The shoulder 18 is formed about the base portion 14 of the abutment 12 using various hand tools, such as spatulas and brushes. The hybrid ceramic material may be formed about the entire length 20 or a portion of the length 22 of the abutment 12 so as to change or alter the angulation and color of the abutment 12. The hybrid ceramic material shoulder can be constructed onto either an opaque metal cylinder abutment or a zirconia or alumina cylinder abutment. A zirconia cylinder abutment will transmit even more light than the opaque metal cylinder abutment. The present invention can also be utilized with all standard fixture platforms currently available.

In another embodiment of the present invention, where an aluminous oxide abutment or zirconia abutment is used, a ceramic foundation layer is applied to the portion of the abutment 12 about which the shoulder 18 will be formed. This procedure assures a chemical as well as mechanical adhesion of the hybrid ceramic material to the abutment 12. This ceramic foundation layer may also incorporate the use of a pigment to further enhance the final appearance of the shoulder 18.

Once the shoulder 18 is formed about the base portion 14 of the abutment 12, the shoulder 18 is initially cured 15. In one embodiment of the invention, the shoulder 18 is cured by exposing the shoulder 18 to ultraviolet light 17. In one embodiment of the invention, the shoulder 18 is exposed to a high intensity ultraviolet light source by placing the abutment system 10 in a typical dental curing unit. In another embodiment of the invention, the shoulder 18 is exposed to ultraviolet light by the dentist using a hand-held high intensity ultraviolet light source.

Once the shoulder 18 is initially cured, the shoulder 18 is shaped 19 so as to conform to at least one patient-specific criterion. In one embodiment of the invention, additional hybrid ceramic material is added to the shoulder 18 so as conform the shoulder 18 to at least one patient-specific criterion. For example, additional hybrid ceramic material can be added to the shoulder 18 so as to increase its height 24. In another embodiment of the invention, hybrid ceramic material is removed from the shoulder 18 so as to conform the shoulder 18 to at least one patient-specific criterion. For example, hybrid ceramic material can be sanded or ground from the shoulder 18 so as to decrease its widths 26a and/or 26b. In an alternative embodiment of the invention, the shoulder 18 is conformed to multiple patient-specific criteria. In another embodiment of the invention, hybrid ceramic material is added to the shoulder 18 so as to alter angulations 28a and 28b so as to conform the shoulder 18 to a patient-specific criterion.

Once the shoulder 18 has been conformed to the necessary patient-specific criteria, the shoulder 18 is finally cured 21. In one embodiment of the invention, the shoulder 18 is cured by placing the abutment system 10 in a typical dental heat curing unit 23 to a final temperature of about 100-110 degrees Celsius. One such dental heat curing unit is manufactured by Kuraray.

In one embodiment, in order to conform the shoulder 18 to the patient-specific criteria, it may be necessary to add additional hybrid ceramic material to the shoulder 18 more than once. It may also be necessary to add additional hybrid ceramic material to different areas on the shoulder 18 each time hybrid ceramic material is added, or hybrid ceramic material may be added to the shoulder 18 in the same area of the shoulder 18 each time. In another embodiment of the present invention, in order to conform the shoulder 18 to the necessary patient-specific criteria, it may be necessary to remove additional hybrid ceramic material from the shoulder 18 more than once. It may also be necessary to remove additional hybrid ceramic material from different places on the shoulder 18 each time hybrid ceramic material is added, or hybrid ceramic material may be removed from the same area of the shoulder 18 each time. In still another embodiment of the invention, it may be necessary to alternatively add and remove hybrid ceramic material to the shoulder 18 in order to conform the shoulder 18 to the necessary patient-specific criteria.

In another alternate embodiment, as shown in FIG. 1, after the shoulder 18 is finally cured, the shoulder 18 is polished 25. In an embodiment of the invention, the shoulder 18 is polished using a series of polishing wheels 27. In one embodiment, the shoulder 18 is polished using a series of heavy grit, medium grit, and fine grit diamond impregnated silicone polishing wheels, and then polished to a high shine using a felt wheel and Kuraray Estenia® polishing compound.

As shown in FIG. 3, the shoulder 18 can be altered by adding or removing hybrid ceramic material to or from various dimensions of the shoulder 18. The height 24, widths 26a and/or 26b, and/or angulations 28a and/or 28b can all be adjusted.

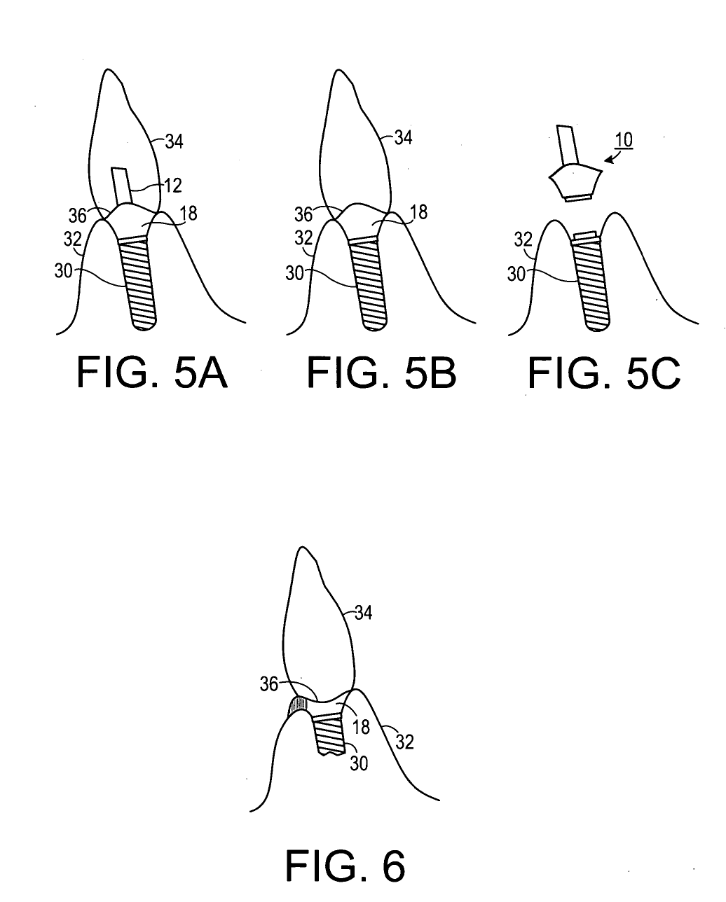

FIG. 5 shows the abutment system 10 as it is affixed to the dental implant 30 in relation to the gum tissue 32. The crown 34 is then affixed over the abutment system 10. The fit of the crown 34 to the shoulder 18 results in little to no margin 36 being visible.

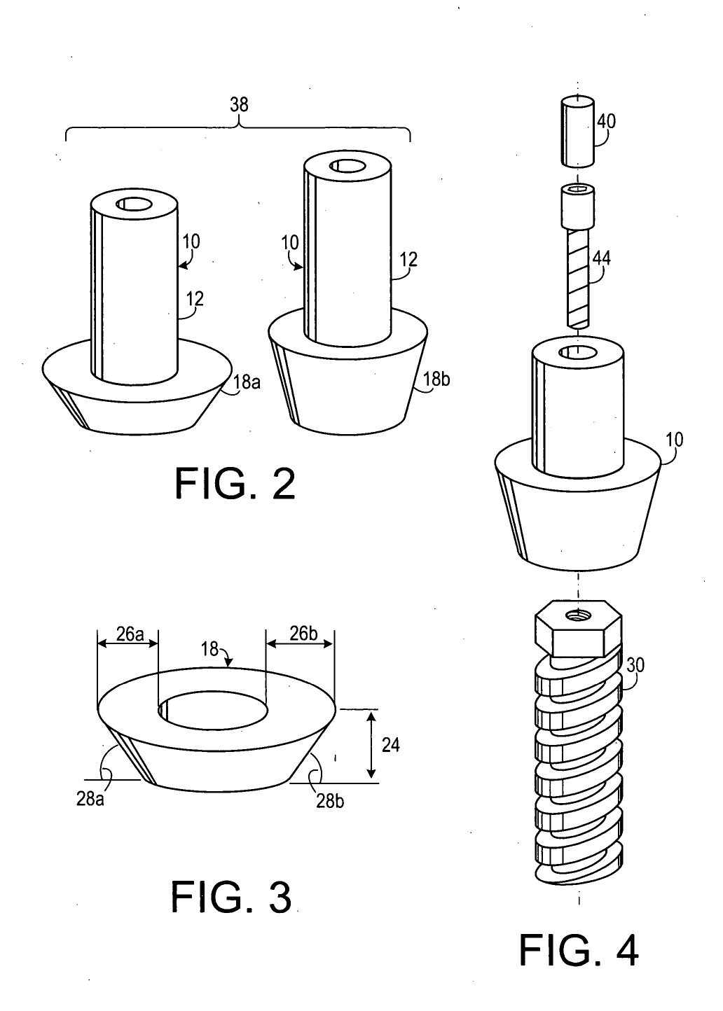

In another embodiment of the invention, as shown in FIG. 2, a plurality of abutment systems 10 are located in a kit 38. Each abutment system 10 is manufactured according to a specific set of patient-specific criteria, and then grouped in a kit 38 with all other abutment systems 10 that were manufactured according to the same specific set of patient-specific criteria. The kit 38 may include shoulders 18 of different form factors that are supplied with at least one abutment 12 (but segregated there from). For example, shoulder 18a is shorter and has a greater diameter than shoulder 18b, thus the implantologist would select shoulder 18a to fill a relatively narrower and shorter incision, rather than shoulder 18b. The shoulder 18 may be affixed to the abutment 12 using an adhesive.

In yet another embodiment, shown in FIG. 6, pigment is added to an amount of hybrid ceramic material prior to adding that amount of hybrid ceramic material to the shoulder 18 so as to give the portion of the shoulder 18 extending outward over the gum tissue 32 the appearance of additional gum tissue.

In yet another alternative embodiment, as shown in FIG. 4, an amount of hybrid ceramic material is formed into a plug 40 and is placed into the hollow portion 42 of the abutment 12. FIG. 4 shows how the abutment system 10 is affixed to the dental implant 30 by a screw 44. A plug 40 is then placed into the opening 42 of the abutment 12.

Another advantage of the present invention is the ability to place the abutment onto the fixture at the time of first stage placement surgery. This allows the abutment to function as the healing cap and model the tissue during the integration stage of healing. This also facilitates the use of a temporary crown over the abutment so as to create an immediate load environment. Immediate loading is extremely beneficial to the integration stage of the fixture into the bone, and is highly preferred by the patient.

Another component of the present invention is the use of plastic try-in abutments to determine the correct size, shape and angulation of the permanent abutment. These plastic abutments are used by oral surgeons at the time of implant placement surgery, and the information gathered at that time allows the surgeon or restorative dentist to choose the most appropriate permanent abutment. These plastic try-in abutments can be manufactured from any plastic material. In an embodiment of the invention, the plastic try-in abutments are manufactured from an autoclavable plastic material, which allows the dentist to sterilize the plastic try-in abutment and therefore use the plastic try-in abutments with more than one patient.

In one embodiment, the plastic material that is used to manufacture the plastic try-in abutments is Delrin®, an acetyl resin that is manufactured by DuPont. In addition to the plastic abutments, hybrid ceramic shells consisting of predetermined shapes and sizes that correspond to the various teeth are available to be placed directly onto the permanent abutment for the purpose of immediate temporization. This alleviates the time intensive procedure of fabricating temporaries in the traditional method. This provides the oral surgeon with the ability to select the correct permanent abutment at the time of first stage surgery. The final abutment can be determined and placed by utilizing a series of preformed try-in abutments to determine the angulation, tissue height, tissue emergence contour, margin height and overall size in relation to the hard and soft tissues. After placement of the permanent abutment, a temporary crown may also be placed by the oral surgeon. This creates a highly favorable environment known as immediate loading.

Another advantage of the present invention is the relative ease of temporization by utilizing pre-formed hybrid ceramic shells as temporary crowns placed on permanent abutment that are placed at the time of first stage surgery. The shells can be preliminarily tacked into place on the abutment to verify correct profile, angulation, occlusal contact, proximal contact, and emergence profile. The shells may be manufactured to any shape or size, so the shell may be in the location of anterior or posterior teeth, and may be used to represent the front, top or back of the tooth. After verification of required placement the shell is then filled in on the underside with additional hybrid ceramic material so as to fully adapt to the abutment. This facilitates extremely accurate and natural looking temporary crowns. This procedure is particularly favorable for immediate load temporization.

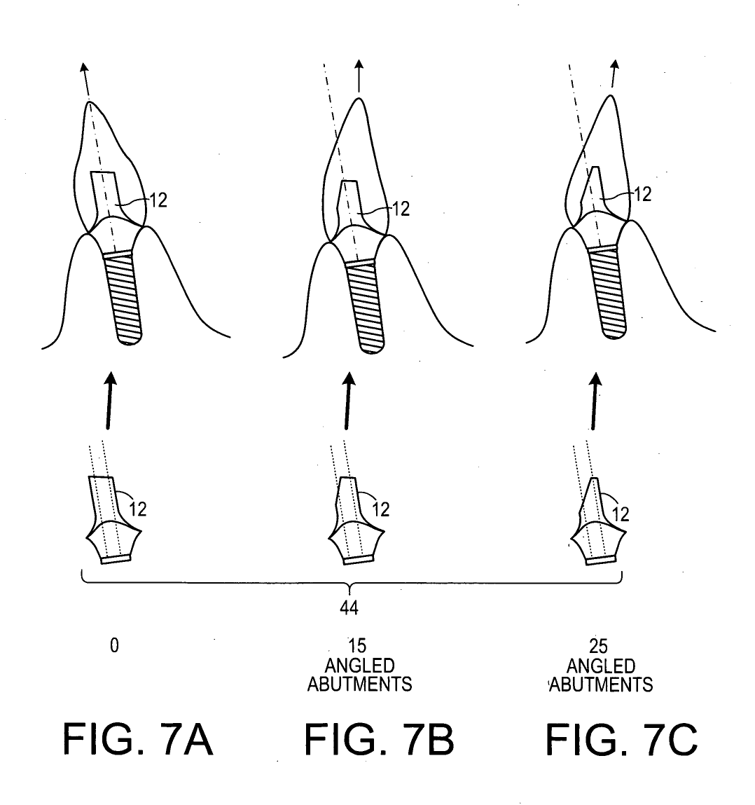

In one embodiment of the present invention, the abutment 12 can be manufactured from an autoclavable plastic material to create a temporary plastic try-in abutment. As shown in FIG. 7, a plurality of plastic try-in abutments 12 is located in a kit 46. Each try-in abutment 12 is manufactured according to a specific set of patient criteria, and then grouped in a kit 44 with all other try-in abutments 12 that were manufactured according to the same specific set of patient-specific criteria

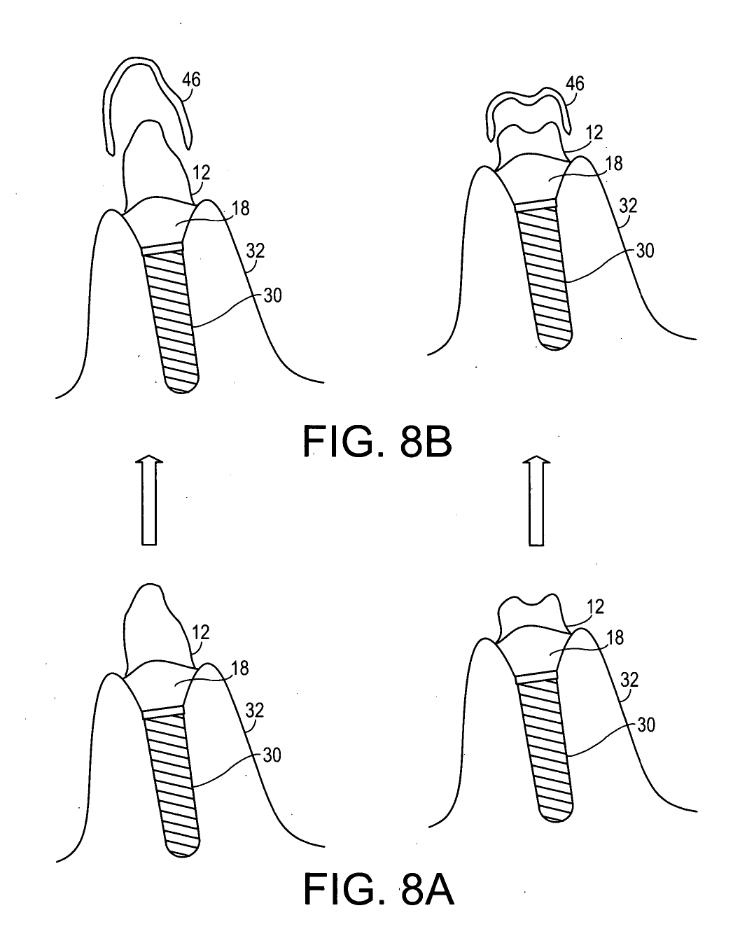

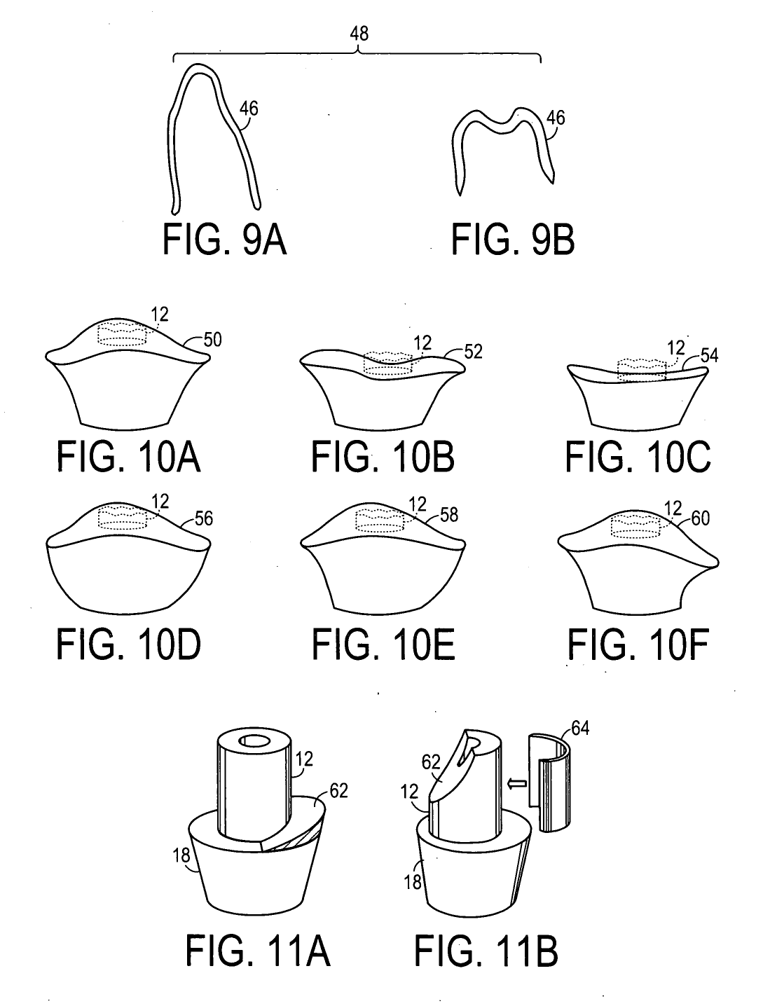

In another embodiment, as shown in FIGS. 8a and 8b, a hybrid ceramic shell 46 is affixed to an abutment 12. As shown in FIG. 9, a plurality of shells 46 is located in a kit 48. Each shell 46 is manufactured according to a specific set of patient criteria, and then grouped in a kit 48 with other shells 46 that were manufactured according to the same specific set of patient-specific criteria.

The form factor of the shoulder may be customized to fit the specific requirements of the patient. As shown in FIGS. 10A-10F, the shoulders may include a plurality of form factors, which may include different top surface shapes and side surface contours. For example, FIG. 10A shows a shoulder 50 with a concave side contour and a convex top surface. A shoulder 52 with scalloped top surface is shown in FIG. 10B, whereas a shoulder 54 with a concave top surface is shown in FIG. 10C. A shoulder 56 with a convex side contour is shown in FIG. 10D and a shoulder 58 with a side contour evolving from being concave on one side to convex on the opposite side is shown in FIG. 10E. A shoulder 60 with on side being longer that the other side is shown in FIG. 10F. As is understood, any combination of these form factors may be employed to make a patient-specific abutment system.

In practice, as shown in FIG. 11A, if the shoulder 18 needs to be heightened on one side, the implantologist may add a wedge 62, or other shaped portion, of the hybrid ceramic to build up the shoulder 18 to the desired shape. Also, as shown in FIG. 11B, the implantologist may add hybrid ceramic material 64 to the abutment 62 to build up one side of the abutment 62 when a portion 62 of the abutment is removed to adapt it to patient-specific angulation requirements.

The above-described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

1. An abutment system for a dental implant, comprising:
a. an abutment having a base portion that is engageable with the implant; and
b. a shoulder, disposed about the base portion, that includes a hybrid ceramic material, the hybrid ceramic material including an organic matrix and at least 80% inorganic filler by weight.

2. The abutment system of claim 1, wherein the shoulder has a form factor that conforms to a patient-specific criterion.

3. The abutment system of claim 2, wherein the form factor includes a scalloped top.

4. The abutment system of claim 2, wherein the form factor includes a concave side.

5. The abutment system of claim 2, wherein the form factor includes a convex side.

6. The abutment system of claim 2, wherein the form factor includes a side portion that is convex and a side portion that is concave.

7. The abutment system of claim 1, wherein the organic matrix comprises a polymer resin.

8. The abutment system of claim 7, wherein the polymer resin comprises at least one dimethylacrylate monomer.

9. The abutment system of claim 1, wherein the inorganic filler comprises a ceramic material having a particle size of no larger than particle size 2 μm.

10. The abutment system of claim 9, wherein the inorganic filler comprises a ceramic material having a particle size of no larger than particle size 0.02 μm.

11. The abutment system of claim 1, wherein the inorganic filler comprises a silica quartz glass.

12. The abutment system of claim 1, further comprising a hybrid ceramic build up portion affixed thereto.

13. The abutment system of claim 12, wherein the hybrid ceramic build up portion comprises hybrid ceramic material applied to the shoulder.

14. The abutment system of claim 12, wherein the hybrid ceramic build up portion comprises hybrid ceramic material applied to the abutment.

15. The abutment system of claim 11, wherein the inorganic filler comprises a plurality of grains and wherein at least one grain is coated with an adhesive.

16. The abutment system of claim 1, wherein the shoulder is separate from the abutment until it is affixed to the abutment by an oral healthcare professional.

17. The abutment system of claim 1, wherein the shoulder is separate from the abutment until it is affixed to the abutment at a dental laboratory.

18. An abutment system kit, comprising:
a. at least one abutment; and
b. a plurality of shoulders, each shoulder enagageable with the abutment, each shoulder having a different form factor so as to conform with a different patient-specific criteria, so that a user can select a shoulder corresponding to a predetermined patient-specific criteria and affix the selected shoulder to the abutment thereby creating a patient-specific abutment system.

19. The abutment system kit of claim 18, wherein at least one of the plurality of shoulders comprises a hybrid ceramic.

20. A method of preparing an abutment system, including an abutment and a shoulder, comprising the steps of:
a. measuring a patient-specific criterion;
b. applying a hybrid ceramic material to the abutment system so that the abutment system conforms to the patient-specific criterion; and
c. curing the hybrid ceramic material.

21. The method of claim 20, wherein the curing step comprises the steps of:
a. partially curing the hybrid ceramic material; and
b. after the partially curing step then permanently curing the hybrid ceramic material.

22. The method of claim 21, wherein the partially curing step comprises the step of subjecting the hybrid ceramic material to light of a predetermined frequency.

23. The method of claim 21, wherein the permanently curing step comprises the step of subjecting the hybrid ceramic material to heat of a predetermined temperature.

24. The method of claim 20, wherein the shoulder has a top surface and wherein the applying step comprises applying the hybrid ceramic material to a portion of the top surface.

25. The method of claim 20, wherein the applying step comprises applying the hybrid ceramic material to a portion of the abutment.

26. The method of claim 20, wherein the hybrid ceramic material comprises at least 80%, by weight of an inorganic filler.

27. A method of making a dental abutment system, comprising the steps of:
a. delivering an abutment to a post-manufacturing dental facility;
b. delivering a shoulder, that fits about at least a portion of the abutment, to the post-manufacturing dental facility; and
c. affixing the shoulder to the abutment at the post-manufacturing dental facility.

28. The method of claim 27, wherein the post-manufacturing dental facility comprises a dental clinic.

29. The method of claim 27, wherein the post-manufacturing dental facility comprises a dental laboratory.

30. The method of claim 27, further comprising the step of manufacturing the abutment from a hybrid ceramic material.

31. The method of claim 30, wherein the hybrid ceramic material comprises at least 80% by weight of an inorganic filler.
